(19) United States
(12) Patent Application Publication
(10) Pub. No.: US 2026/0037928 A1
(43) Pub. Date: Feb. 5, 2026

(54) INFORMATION PROCESSING APPARATUS AND METHOD

(71) Applicant: TOYOTA JIDOSHA KABUSHIKI KAISHA, Toyota-shi (JP)

(72) Inventor: Yusuke TAMAYAMA, Tokyo-to (JP)

(73) Assignee: TOYOTA JIDOSHA KABUSHIKI KAISHA, Toyota-shi (JP)

(21) Appl. No.: 19/281,858

(22) Filed: Jul. 28, 2025

(30) Foreign Application Priority Data
Jul. 30, 2024 (JP) 2024-122967

(51) Int. Cl. G06Q 10/1091; G07C 5/04

(52) U.S. Cl. CPC G06Q 10/1091; G07C 5/04

(57) ABSTRACT

An information processing apparatus includes a control unit that executes: for a predetermined period, acquiring traveling information of a first vehicle to be used by a first user, the traveling information including at least position information and a time at which the position information is acquired; acquiring declaration information regarding an attendance status declared from the first user; and generating attendance information of the first user based on the traveling information of the first vehicle and the declaration information.

### CROSS-REFERENCE TO RELATED APPLICATION

This application claims priority to Japanese Patent Application No. 2024-122967 filed on Jul. 30, 2024, incorporated herein by reference in its entirety.

### BACKGROUND

### 1. Technical Field

The present disclosure relates to attendance management of a driver of a commercial vehicle.

### 2. Description of Related Art

A labor state management device that manages a labor state of a driver based on a work category input by the driver from an input device mounted on a vehicle has been disclosed (for example, Japanese Unexamined Patent Application Publication No. 2019-067428 (JP 2019-067428 A)).

### SUMMARY

The present disclosure is directed to providing an information processing apparatus and a method capable of simplifying an input work of a driver of a vehicle regarding attendance of the driver.

One aspect of the present disclosure relates to an information processing apparatus including a control unit. The control unit executes, for a predetermined period, acquiring traveling information of a first vehicle to be used by a first user, the traveling information including at least position information and a time at which the position information is acquired, acquiring declaration information regarding an attendance status declared from the first user, and generating attendance information of the first user based on the traveling information of the first vehicle and the declaration information.

Another aspect of the present disclosure relates to a method to be executed by a computer. The method includes, for a predetermined period, acquiring traveling information of a first vehicle to be used by a first user, the traveling information including at least position information and a time at which the position information is acquired, acquiring declaration information regarding an attendance status declared from the first user, and generating attendance information of the first user based on the traveling information of the first vehicle and the declaration information.

According to the present disclosure, it is possible to simplify an input work of a driver of a vehicle regarding attendance of the driver.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a view illustrating an example of a system configuration of an attendance management system of a driver, and an example of hardware configurations of a management terminal, a vehicle, and a center server according to a first embodiment;

FIG. 2 is a view illustrating an example of functional configurations of the management terminal, the vehicle and the center server;

FIG. 3 is a view illustrating an example of a declaration screen of an attendance status in the vehicle;

FIG. 4 is an example of information to be held in a vehicle traveling information database of the management terminal;

FIG. 5A is an example of a flowchart of generation processing of attendance information of the management terminal;

FIG. 5B is an example of a flowchart of the generation processing of the attendance information of the management terminal;

FIG. 5C is an example of a flowchart of the generation processing of the attendance information of the management terminal; and

FIG. 6 is an example of a flowchart of generation processing of attendance information according to a modification.

### DETAILED DESCRIPTION OF EMBODIMENTS

When attendance of a driver of a vehicle is managed based on declaration regarding attendance from the driver, there are problems that an input work of the driver is troublesome, and the driver may forget declaration. In one aspect of the present disclosure, in view of the above-described problems, attendance of the driver is managed using traveling information of a vehicle on which the driver gets in addition to declaration information regarding attendance from the driver.

One aspect of the present disclosure is an information processing apparatus including a control unit. For a predetermined period, the control unit of the information processing apparatus acquires traveling information of a first vehicle to be used by a first user, the traveling information including at least position information and a time at which the position information is acquired, acquires declaration information regarding an attendance status declared from the first user, and generates attendance information of the first user based on the traveling information of the first vehicle and the declaration information.

The information processing apparatus is, for example, a terminal or a server of a company for which the first user works as an employee, or a terminal or a server of a company that performs attendance management of employees of the company in response to a request from the company for which the first user works as the employee. The terminal is, for example, a computer such as a personal computer (PC), a smartphone and a tablet terminal. The server is, for example, a dedicated computer and a computer such as a PC. The control unit may be, for example, a processor such as a central processing unit (CPU) and a graphics processing unit (GPU) or a circuit such as a field programmable gate array (FPGA).

The first vehicle is a commercial vehicle. The first vehicle is, for example, a vehicle such as a truck, a wagon and a passenger vehicle to be used in transport business and delivery business. The first vehicle may include a bus, a taxi, and the like, that transport humans. The first user is a driver of the first vehicle. The predetermined period may be, for example, a period with a fixed length of a unit such as one day, one week and one month or may be a period with a variable length such as a period from previous processing to processing of this time. The attendance information includes, for example, information such as the number of duties or the number of days, duty hours of each duty, an on-duty period and an off-duty period in a duty period of each time. However, the information included in the attendance information is not limited to these.

One piece of declaration information may include one of information indicating start of a duty, end of a duty, start and end of an on-duty period, start and end of an off-duty period, and a time. In this case, the control unit may specify the start of the duty, the end of the duty, the on-duty period, and the off-duty period based on one or a plurality of pieces of declaration information in the predetermined period. Further, when a first stop period of the first vehicle, equal to or longer than a first threshold time length exists in a period other than the on-duty period and the off-duty period specified based on the one or the plurality of pieces of declaration information, the control unit may specify the first stop period as the off-duty period.

Alternatively, the control unit may generate the attendance information of the first user further based on operation plan information including at least a duty start scheduled time and a duty start scheduled location, and a duty end scheduled time and a duty end scheduled location of the first vehicle in the predetermined period. In this case, the control unit may specify the start of the duty, the end of the duty, the on-duty period, and the off-duty period based on one or a plurality of pieces of declaration information in the predetermined period. When the first stop period of the first vehicle, equal to or longer than the first threshold time length exists in a period other than the on-duty period and the off-duty period specified based on the one or the plurality of pieces of declaration information, (A) when declaration information indicating the end of the duty does not exist immediately before the first stop period, and hours of the first stop period and a position of the first vehicle respectively correspond to the duty end scheduled time and the duty end scheduled location included in the operation plan information, the control unit may determine a start time point of the first stop period as the end of the duty, (B) when the position of the first vehicle in the first stop period is a predetermined location, the control unit may determine the first stop period as the on-duty period, and (C) when the position of the first vehicle in the first stop period is neither a location included in the operation plan information nor the predetermined location, the control unit may determine the first stop period as the off-duty period. The predetermined location is, for example, a location such as a gas station and a charging station, where a power source of a vehicle can be refilled. Further, when declaration information indicating start of the duty does not exist immediately before a first moving period, and the first moving period of the first vehicle, equal to or longer than a second threshold time length exists near the duty start scheduled time, the control unit may determine a start time point of the first moving period as the start of the duty.

According to one aspect of the present disclosure, for example, even when the first user has forgotten declaration regarding the attendance status, the attendance status of the first user is supplemented based on the traveling information of the first vehicle. This makes it possible to grasp the attendance status of the user closer to reality even without a troublesome input work of the user.

As another aspect, the present disclosure can be specified as a method in which a computer executes processing to be executed by the above-described information processing apparatus. As another aspect, the present disclosure can be specified as a program for causing a computer to execute the above-described method and a non-transitory computer-readable recording medium recording the program.

An embodiment of the present disclosure will be described below based on the drawings. A configuration of the following embodiment is an example, and the present disclosure is not limited to the configuration of the embodiment.

### First Embodiment

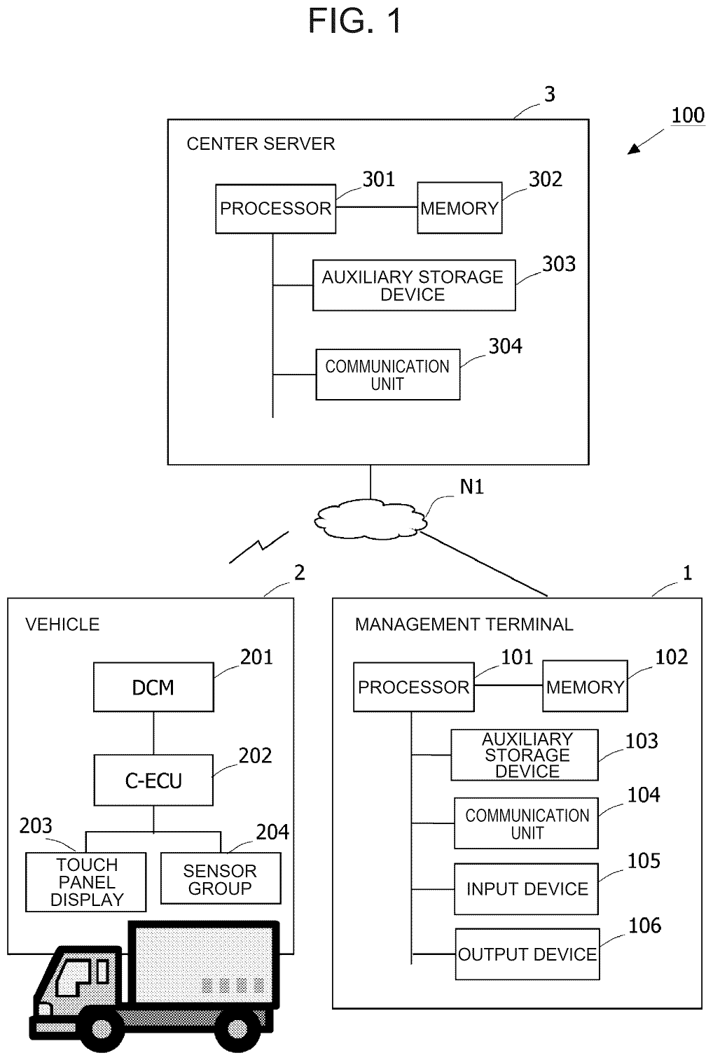

FIG. 1 is a view illustrating an example of a system configuration of a driver attendance management system 100 according to a first embodiment and an example of hardware configurations of a management terminal 1, a vehicle 2, and a center server 3. The attendance management system 100 includes the management terminal 1, the vehicle 2, and the center server 3. The management terminal 1, the vehicle 2, and the center server 3 are connected to a network N1. The network N1 is, for example, a public network such as the Internet. The management terminal 1 and the vehicle 2 can communicate with the center server 3 through the network N1.

The vehicle 2 is a commercial vehicle. It is assumed in the first embodiment that the vehicle 2 is a truck to be used in transport business. However, the vehicle 2 is not limited to the truck to be used in transport business. The vehicle 2 may be, for example, a truck, a wagon, a passenger vehicle, or a bike to be used in transport business and delivery business. The vehicle 2 is, for example, managed by a transport service provider to which a driver of the vehicle 2 belongs.

The vehicle 2 regularly transmits vehicle traveling information to the center server 3. The vehicle traveling information includes, for example, position information of the vehicle 2, a time stamp, sensor information such as a speed, and the like. Further, an input device of an attendance status is mounted on the vehicle 2. Declaration information of the attendance status input to the input device is transmitted from the vehicle 2 to the center server 3 along with the vehicle traveling information. The declaration information includes, for example, identification information of the driver, a time stamp, and an attendance type. The attendance type includes, for example, start of a duty, end of a duty, break, loading, unloading, waiting for loading, and fueling. Each of break, loading, unloading, waiting for loading and fueling further includes types of start and end. Note that the attendance type is not limited to these. For example, the attendance type can be arbitrarily set according to a business type in which the vehicle 2 is used, or a company that manages the vehicle 2. Among the attendance types, types other than start of a duty and end of a duty include types classified into an on-duty period and types classified into an off-duty period. For example, break and waiting for loading are classified into the off-duty period. For example, loading, unloading and fueling are classified into the on-duty period.

The center server 3 is, for example, a server to be managed by a manufacturer of the vehicle 2. The center server 3 holds the vehicle traveling information and the declaration information of the attendance status received from the vehicle 2 as a database. Note that a manager of the center server 3 is not limited to the manufacturer of the vehicle 2, and may be a manufacturer of a DCM 201 mounted on the vehicle 2. The center server 3 transmits the vehicle traveling information of the vehicle 2 and the declaration information of the driver of the vehicle 2 to the management terminal 1 in response to a request from the management terminal 1.

The management terminal 1 is a terminal to be managed by a transport service provider to which the driver of the vehicle 2 belongs. The management terminal 1 acquires the vehicle traveling information of the vehicle 2 and the declaration information of the driver of the vehicle 2 in a predetermined period from the center server 3, for example, at a timing such as once a day, once a week and once a month. A period during which information is to be acquired is, for example, a period from when acquisition of the information is executed last time until when acquisition of the information is executed this time. For example, when acquisition of the information is executed at a predetermined time interval, the information corresponding to the time interval of execution of acquisition of the information is acquired.

In the first embodiment, the management terminal 1 generates attendance information of the driver of the vehicle 2 based on the vehicle traveling information of the vehicle 2, the declaration information of the driver of the vehicle 2, and operation plan information of the vehicle 2 in the predetermined period. The attendance information includes, for example, the number of days of duties, the number of duties, a duty time length in each duty, total duty hours in the predetermined period, and the like. However, information included in the attendance information is not limited to these.

The vehicle 2 is a commercial vehicle, and thus, basically, it can be estimated that the driver of the vehicle 2 is on duty when the vehicle 2 is traveling. Further, also when the vehicle 2 stops, whether or not the driver of the vehicle 2 is on duty can be estimated based on a stop duration and a stop location. For example, when the vehicle 2 stops for a period less than a predetermined period at a location included in the operation plan information, it can be estimated that the driver of the vehicle 2 is performing loading, unloading, or the like, and is on duty. For example, when the vehicle 2 stops for a period equal to or longer than a predetermined time length at a location not included in the operation plan information, it can be estimated that the driver of the vehicle 2 is on a break and is not on duty.

Thus, in the first embodiment, for example, even when the driver of the vehicle 2 has forgotten declaration of the attendance status, whether or not the driver of the vehicle 2 is on duty can be estimated based on the vehicle traveling information and the operation plan information of the vehicle 2. This can prevent a work to be performed by the driver regarding declaration of the attendance status from becoming troublesome. The vehicle 2 is an example of a “first vehicle”. The driver of the vehicle 2 is an example of a “first user”.

A hardware configuration of each device will be described next. The management terminal 1 can be constituted with a personal computer (PC), a workstation (WS), or an information processing apparatus (computer) such as server machine, a smartphone and a tablet terminal. The management terminal 1 may be an aggregate (cloud) of one or more computers. The management terminal 1 is an example of an “information processing apparatus”.

The management terminal 1 includes a processor 101, a memory 102, an auxiliary storage device 103, a communication unit 104, an input device 105 and an output device 106 as hardware components. The memory 102 and the auxiliary storage device 103 are computer-readable recording media.

The auxiliary storage device 103 stores various kinds of programs, and data to be used by the processor 101 upon execution of each program. The auxiliary storage device 103 is, for example, an erasable programmable read-only memory (EPROM), a hard disk drive or a solid state drive (SSD). The programs to be held in the auxiliary storage device 103 include, for example, an operating system (OS), an application program, a driver attendance management program, and the like. The driver attendance management program is a program that generates attendance information of the driver based on the vehicle traveling information of the vehicle 2, the declaration information regarding the attendance status of the driver, and the operation plan information of the vehicle 2.

The memory 102 is a storage device that provides to the processor 101, a storage area to which the program stored in the auxiliary storage device 103 is to be loaded, and a work area, or is used as a buffer. The memory 102 includes, for example, a semiconductor memory such as a read only memory (ROM) and a random access memory (RAM).

The processor 101 executes various kinds of processing by loading the programs held in the auxiliary storage device 103 to the memory 102 and executing the programs. The processor 101 is, for example, a CPU, a GPU, a digital signal processor (DSP), or the like. The number of processors 101 is not limited to one, and a plurality of processors 101 may be provided. The processor 101 is one example of a “control unit”.

The communication unit 104 is, for example, a network interface card (NIC), an optical line interface, or the like. Note that the communication unit 104 may be, for example, a wireless communication circuit to be connected to a wireless network of a mobile wireless communication network, and the like, such as a wireless LAN, 5G, long term evolution (LTE) and 6G.

The input device 105 is, for example, a keyboard, a mouse, a touch panel, or the like. The input device 105 may be a sound input device such as a microphone. The output device 106 is, for example, a display, or the like. The output device 106 may be a sound output device such as a speaker. Note that hardware components of the management terminal 1 are not limited to those illustrated in FIG. 1. The management terminal 1 may be a device including a dedicated electric circuit such as a field-programmable gate array (FPGA) or an application specific integrated circuit (ASIC) that executes corresponding processing.

Next, the center server 3 can be constituted using an information processing apparatus (computer) such as server machine. The center server 3 may be an aggregate (cloud) of one or more computers. The center server 3 includes a processor 301, a memory 302, an auxiliary storage device 303 and a communication unit 304 as hardware components. The processor 301, the memory 302, the auxiliary storage device 303 and the communication unit 304 are respectively similar to the processor 101, the memory 102, the auxiliary storage device 103 and the communication unit 104. However, programs to be held in the auxiliary storage device 303 of the center server 3 include, for example, an OS, an application program, a management program of the vehicle traveling information, and the like.

Next, the vehicle 2 includes a DCM 201, a C-ECU 202, a touch panel display 203, and a sensor group 204. The DCM 201 and the C-ECU 202 are, for example, connected by an in-vehicle LAN. Further, the C-ECU 202, the touch panel display 203, and the sensor group 204 are, for example, connected by a controller area network (CAN). However, the connection method among the DCM 201, the C-ECU 202, the touch panel display 203 and the sensor group 204 is not limited to these. Note that in FIG. 1, hardware components related to processing according to the first embodiment are extracted and illustrated for convenience sake, and the vehicle 2 includes other hardware components, and the like, for controlling traveling.

The sensor group 204 includes, for example, sensors such as a position acquisition sensor and a speedometer. The position acquisition sensor includes, for example, a global positioning system (GPS) receiver. Note that the sensors included in the sensor group 204 are not limited to the position acquisition sensor and the speedometer.

The touch panel display 203 displays an attendance menu screen and accepts input of the attendance type declared by the driver in the first embodiment. The touch panel display 203 transmits the attendance type input by operation by the driver to the DCM 201 through the C-ECU 202.

The C-ECU 202 acquires detection values of the respective sensors of the sensor group 204 in response to a request from the DCM 201 and outputs the detection values to the DCM 201 in the first embodiment. The detection value of the position acquisition sensor is position information of a current value of the vehicle 2. The position information is, for example, latitude and longitude. The detection value of the speedometer is a speed of the vehicle 2.

The DCM 201 includes a processor, a memory, an auxiliary storage device, a wireless communication unit, and an interface with the in-vehicle network. The wireless communication unit of the DCM 201 is, for example, connected to a network N1 through a mobile communication network such as 5G, LTE and 6G to enable communication with the center server 3. The DCM 201 acquires detection values of the respective sensors of the sensor group 204 through the C-ECU 202, generates vehicle traveling information and transmits the vehicle traveling information to the center server 3 at predetermined periods. A generation period of the vehicle traveling information is, for example, between one second to one minute, and can be arbitrarily set by a manufacturer of the vehicle 2 or a manager of the vehicle 2.

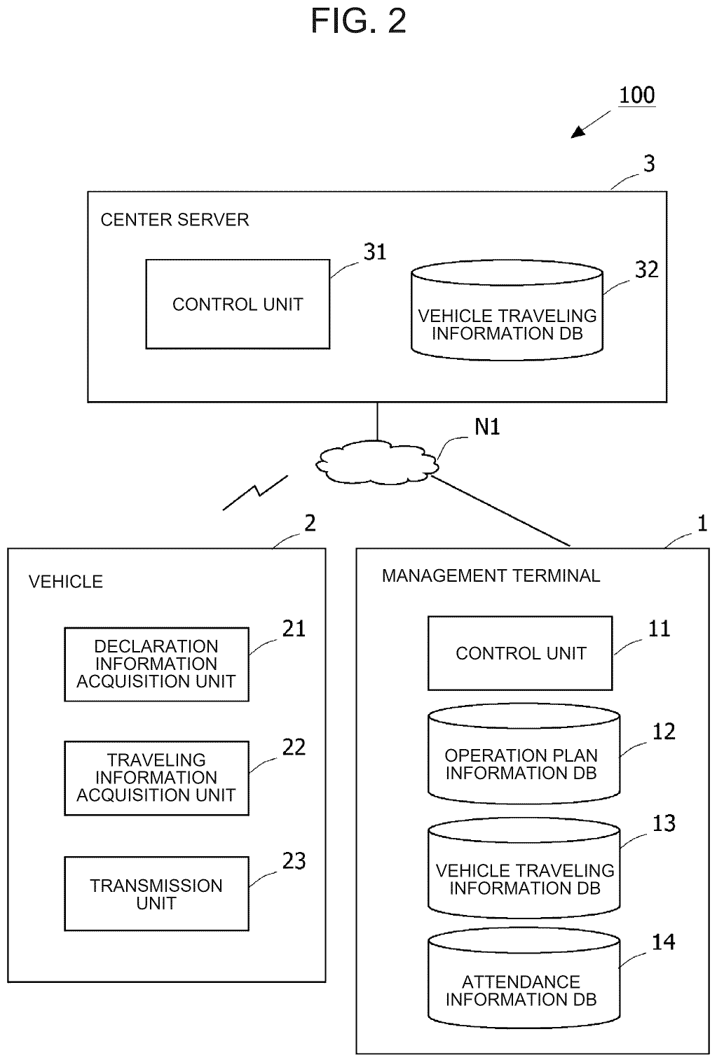

FIG. 2 is a view illustrating an example of functional components of the management terminal 1, the vehicle 2, and the center server 3. The vehicle 2 includes a declaration information acquisition unit 21, a traveling information acquisition unit 22, and a transmission unit 23 as the functional components. The declaration information acquisition unit 21, the traveling information acquisition unit 22, and the transmission unit 23 are components having functions to be implemented by processing by the DCM 201. Note that each or part of the declaration information acquisition unit 21, the traveling information acquisition unit 22, and the transmission unit 23 may correspond to different programs or different hardware components (such as an FPGA).

The declaration information acquisition unit 21 accepts input of user operation regarding declaration of the attendance status to the touch panel display 203. For example, the declaration information acquisition unit 21 displays a declaration screen of the attendance status on the touch panel display 203 in accordance with user operation. Further, when an attendance type to be declared is input to the declaration screen of the attendance status, the declaration information acquisition unit 21 outputs the attendance type to the transmission unit 23 as the declaration information along with the identification information of the driver.

The traveling information acquisition unit 22 generates vehicle traveling information at predetermined periods. When a timing of generating the vehicle traveling information comes, the traveling information acquisition unit 22 acquires the detection values from the respective sensors included in the sensor group 204 and generates the vehicle traveling information. The vehicle traveling information includes at least position information and a speed of the vehicle 2 in the first embodiment. The traveling information acquisition unit 22 outputs the generated vehicle traveling information to the transmission unit 23.

When the transmission unit 23 accepts input of the vehicle traveling information from the traveling information acquisition unit 22, the transmission unit 23 transmits the vehicle traveling information to the center server 3. When the transmission unit 23 accepts input of the declaration information from the declaration information acquisition unit 21, the transmission unit 23 transmits the declaration information to the center server 3 along with the vehicle traveling information that is regularly input thereafter. When the transmission unit 23 transmits some kind of information to the center server 3, the transmission unit 23 transmits the information along with the identification information of the vehicle 2 and a time stamp. The time stamp may be, for example, a transmission time or a generation time of the information to be transmitted.

Then, the center server 3 includes a control unit 31 and a vehicle traveling information DB 32 as functional components. The control unit 31 receives the vehicle traveling information or the vehicle traveling information and the declaration information from the vehicle 2. The control unit 31 stores the received traveling information and declaration information in the vehicle traveling information DB 32. The vehicle traveling information DB 32 is created in the storage area of the auxiliary storage device 303. The vehicle traveling information DB 32 stores the vehicle traveling information and the declaration information.

When the control unit 31 receives an acquisition request regarding the vehicle traveling information and the declaration information from the management terminal 1, the control unit 31 reads out the vehicle traveling information of the vehicle 2 and the declaration information in a designated period from the vehicle traveling information DB 32 and transmits the vehicle traveling information and the declaration information to the management terminal 1.

Then, the management terminal 1 includes a control unit 11, an operation plan information DB 12, a vehicle traveling information DB 13, and an attendance information DB 14 as functional components. The control unit 11 is, for example, a functional component for which processing is to be implemented by the processor 101 executing a driver attendance management program stored in the auxiliary storage device 103. The operation plan information DB 12, the vehicle traveling information DB 13 and the attendance information DB 14 are created in the storage area of the auxiliary storage device 103.

The operation plan information DB 12 stores the operation plan information of the vehicle 2. The operation plan information includes, for example, identification information of the vehicle 2, identification information of the driver of the vehicle 2, a duty start scheduled location and a duty start scheduled time, and a duty end scheduled location and a duty end scheduled time of each duty in a predetermined period, and one or more stop-off scheduled points or stop-off scheduled times. The stop-off scheduled points of the vehicle 2 include, for example, scheduled locations where loading into and unloading from the vehicle 2 are to be performed. Information regarding locations included in the operation plan information may be, for example, any of latitude and longitude, address, building name, and the like.

The vehicle traveling information DB 13 stores the vehicle traveling information of the vehicle 2 acquired from the center server 3. In the first embodiment, the declaration information is also stored in the vehicle traveling information DB 13 along with the vehicle traveling information. The information stored in the vehicle traveling information DB 13 will be described in detail later.

The attendance information DB 14 stores attendance information of the driver of the vehicle 2, generated by the control unit 11 based on the vehicle traveling information of the vehicle 2 and the declaration information from the driver. The attendance information includes, for example, a duty day, duty hours per one duty, the number of days of duties and total duty hours in a predetermined period, information regarding the attendance status of each duty, and the like. The information regarding the attendance status includes, for example, a duty start time and a duty start location, a duty end time and a duty end location, start times, end times, locations, and the like, of a break, unloading, loading, and the like. However, the information included in the attendance information and the information regarding the attendance status is not limited to these.

The control unit 11 transmits an acquisition request of the vehicle traveling information of the vehicle 2 and the declaration information to the center server 3 at a predetermined timing. For example, an acquisition target period, the identification information of the vehicle 2, and the identification information of the driver are also transmitted along with the acquisition request. The control unit 11 receives the vehicle traveling information of the vehicle 2 and the declaration information of the driver in the designated period from the center server 3 as a response to the acquisition request and stores the vehicle traveling information and the declaration information in the vehicle traveling information DB 13.

The control unit 11 generates attendance information of the driver of the vehicle 2 based on the declaration information of the driver, the vehicle traveling information and the operation plan information of the vehicle 2. The attendance types of the driver include a type that becomes an on-duty period and a type that becomes an off-duty period. For example, a break is classified into an off-duty period, and a break time is not counted in the duty time length. For example, fueling is classified into an on-duty period, and a period required for fueling is counted in the duty time length. The control unit 11 specifies an on-duty period and an off-duty period in the duty period from start of the duty to end of the duty and generates attendance information based on the specification result.

The control unit 11 gives preference on specification using the declaration information from the driver in specification of the on-duty period and the off-duty period in the duty period. However, there is a case where the declaration information does not exist as a result of the driver having forgotten declaration of content of attendance. Thus, the control unit 11 specifies a moving period and a stop period of the vehicle 2 based on the vehicle traveling information of the vehicle 2. Basically, the control unit 11 determines the moving period of the vehicle 2 as the duty hours. When the stop period of the vehicle 2, equal to or longer than a predetermined time length exists other than the on-duty period and the off-duty period specified based on the declaration information, the control unit 11 checks the operation plan information of the vehicle 2 to determine whether the stop period is the on-duty period or the off-duty period.

The control unit 11 generates the attendance information based on the specification result of the on-duty period and the off-duty period in each duty. The control unit 11 stores the generated attendance information in the attendance information DB 14. Note that generation processing of the attendance information of the control unit 11 will be described in detail later. Further, the acquisition processing of the vehicle traveling information and the declaration information from the center server 3 by the control unit 11 and the generation processing of the attendance information may be continuously executed or may be independently executed. Note that the functional components of the management terminal 1, the vehicle 2, and the center server 3 are not limited to the example illustrated in FIG. 2.

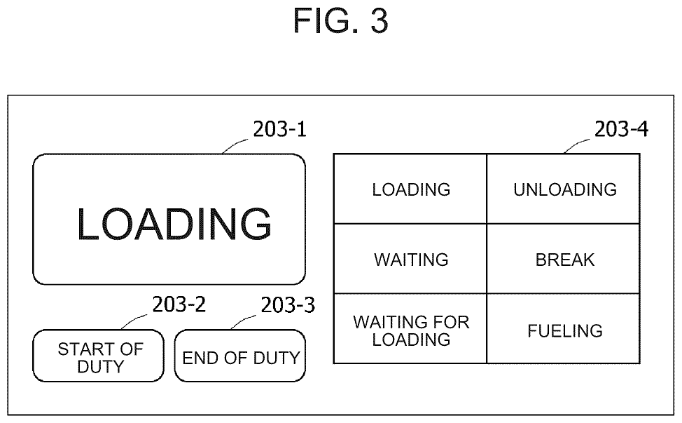

FIG. 3 is a view illustrating an example of the declaration screen of the attendance status in the vehicle 2. The declaration screen of the attendance status is, for example, displayed on the touch panel display 203 mounted on the vehicle 2. The declaration screen of the attendance status illustrated in FIG. 3 includes a display field 203-1 of a current attendance type, a duty start button 203-2, a duty end button 203-3, and an attendance type button group 203-4. The attendance type button group 203-4 includes buttons of “loading”, “unloading”, “waiting”, “break”, “waiting for loading” and “fueling”

“Loading” indicates a period during which a shipment is loaded on the vehicle 2. “Unloading” indicates a period during which a shipment is unloaded from the vehicle 2. “Waiting” indicates a period during which the vehicle waits for the purpose other than loading or unloading. “Break” indicates a break time. “Waiting for loading” indicates a period during which the vehicle waits for the purpose of loading or unloading. “Fueling” indicates a period during which the vehicle 2 is fueled. In the first embodiment, periods of “loading”, “unloading”, “waiting” and “fueling” are dealt with as on-duty periods, and periods of “waiting for loading” and “break” are dealt with as off-duty periods. Note that setting of attendance types and types of duties that become on-duty periods and off-duty periods depends on a type of business, business content, a company, or the like.

Before the declaration screen of the attendance status is displayed, for example, the driver of the vehicle 2 logs into the attendance management system 100 using the own identification information of the driver through a login screen. For example, if “declaration of attendance” is selected from a menu screen of the attendance management system 100, the declaration screen of the attendance status is displayed. On the declaration screen of the attendance status, the attendance type button group 203-4 is displayed so that any button can be selected as an initial state. Further, in the initial state, none of the attendance types is displayed in the display field 203-1.

In the first embodiment, the driver depresses (or selects) the duty start button 203-2 or the duty end button 203-3 upon start or end of the duty. If operation of selecting the duty start button 203-2 or the duty end button 203-3 is performed, the declaration information acquisition unit 21 outputs start of the duty or end of the duty to the transmission unit 23 as the declaration information.

In the first embodiment, the driver performs operation of depressing (or selecting) the corresponding attendance type button on the declaration screen of the attendance status upon start and end of a period of any attendance type.

Among the attendance type button group 203-4, if user operation of selecting any one of the buttons is performed in the initial state, the attendance type corresponding to the selected button is displayed in the display field 203-1. Further, display of the attendance type button group 203-4 transitions to display in a such state that the selected button is selectable and buttons that are not selected are not selectable. When any one of the buttons is selected in the initial state, the declaration information acquisition unit 21 detects input of user operation of start of the period of the attendance type corresponding to the selected button and outputs the type (start) of the duty to the transmission unit 23 as the declaration information. A display method of the attendance type buttons in a state where the buttons cannot be selected includes, for example, a method in which a display method of a selectable button is made different from a display method of non-selectable buttons such as a method in which a selectable button is displayed in color, and non-selectable buttons are displayed in grayscale.

If user operation of selecting a selectable button is performed in a state where the attendance type button group 203-4 is displayed in such a state that the selected button is selectable, and other buttons that are not selected are not selectable, display of the display field 203-1 and the attendance type button group 203-4 returns to the initial state. Further, the declaration information acquisition unit 21 detects input of the user operation of end of a period of the attendance type corresponding to the selected button and outputs the type (end) of the duty to the transmission unit 23 as the declaration information. Note that the declaration information of the same type that is to be a set of start and end of one attendance type may be made identifiable by the same number being added to the set, or the like.

Further, there is a case where the driver may forget declaration upon end of a certain attendance type. Thus, in the first embodiment, when the button of the attendance type is not selected again even after a predetermined period has elapsed after the button of the attendance type is selected by declaration of start of the period of the attendance type, the declaration screen of the attendance status transitions to the initial state. Thus, in the first embodiment, there can be a case where only declaration information indicating start of a period of a certain attendance type exists, and declaration information indicating end of the period of the attendance type that is to be a set does not exist. On the other hand, in the first embodiment, there is no case where only declaration information indicating end of a period of a certain attendance type exists, and declaration information indicating start of the period of the attendance type that is to be a set does not exist.

Note that a configuration of the declaration screen of the attendance status, transition of display, and the like, illustrated in FIG. 3 are one example, and the configuration, the transition, and the like, are not limited to the example illustrated in FIG. 3. For example, each of the attendance type button group 203-4 may include a start button and an end button.

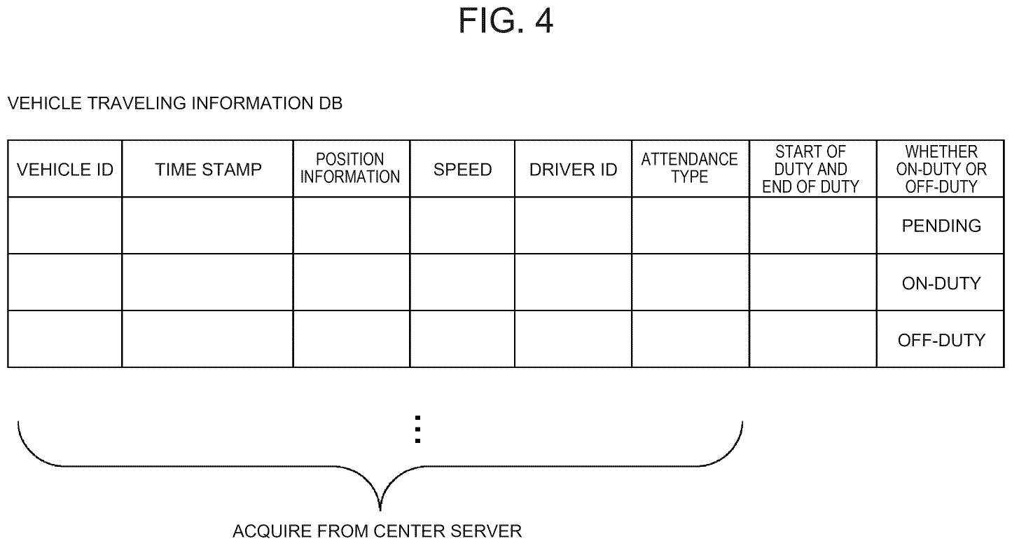

FIG. 4 is an example of information to be held in the vehicle traveling information DB 13 of the management terminal 1. The vehicle traveling information DB 13 stores the vehicle traveling information of the vehicle 2, and the declaration information of the attendance status of the driver. One record of the information to be held in the vehicle traveling information DB 13 includes fields of a vehicle ID, a time stamp, position information, a speed, a driver ID, an attendance type, start of the duty and end of the duty, and whether on-duty or off-duty. Values of the fields of the vehicle ID, the time stamp, the position information, the speed, the driver ID and the attendance type can be acquired by the management terminal 1 from the center server 3. In other words, the vehicle traveling information DB 32 of the center server 3 stores records including the fields of the vehicle ID, the time stamp, the position information, the speed, the driver ID, and the attendance type.

In the field of the vehicle ID, identification information of the vehicle 2 is stored. In the field of the time stamp, a time stamp of the vehicle traveling information included in the record is stored. In the field of the position information, position information of the vehicle 2 at a time indicated by the field of the corresponding time stamp is stored. In the field of the speed, a speed of the vehicle 2 at a time indicated by the field of the corresponding time stamp is stored. Information stored in the fields of the vehicle ID, the time stamp, the position information and the speed is information included in the vehicle traveling information transmitted from the vehicle 2.

In the field of the driver ID, identification information of the driver of the vehicle 2 is stored. In the field of the attendance type, an attendance type is stored. Information stored in the fields of the time stamp, the driver ID, and the attendance type is information included in the declaration information transmitted from the vehicle 2. Note that in the first embodiment, it is assumed that the declaration information is transmitted from the vehicle 2 along with the vehicle traveling information, and thus, when the declaration information is not transmitted along with the vehicle traveling information, the fields of the driver ID and the attendance type are blank.

The fields of the start of the duty and end of the duty, and whether on-duty or off-duty are fields to be utilized when the control unit 11 executes generation processing of the attendance information in the first embodiment. The fields of the start of the duty and end of the duty, and whether on-duty or off-duty are blank in an initial state, and predetermined values are stored as a result of execution of the generation processing of the attendance information by the control unit 11.

In the field of the start of the duty and the end of the duty, a value indicating that the vehicle traveling information included in the record is a timing of start of the duty, a value indicating that the vehicle traveling information is a timing of end of the duty or a value indicating that the vehicle traveling information is a timing not corresponding to these is stored. When the vehicle traveling information included in the record is a timing of start of the duty or end of the duty, in the field of start of the duty and end of the duty, “start of the duty” indicating that the vehicle traveling information is a timing of start of the duty or “end of the duty” indicating that the vehicle traveling information is a timing of end of the duty is stored. When the vehicle traveling information included in the record is neither a timing of start of the duty nor a timing of end of the duty, in the field of start of the duty and end of the duty, information indicating “no” indicating that the vehicle traveling information is neither a timing of start of the duty nor a timing of end of the duty is stored or when the vehicle traveling information included in the record is a timing of start of the duty or a timing of end of the duty, the field of start of the duty and end of the duty is blank.

In the field of whether on-duty or off-duty, information indicating whether the vehicle traveling information included in the record corresponds to an on-duty period is stored. In the field of whether on-duty or off-duty, one of information indicating “on-duty” indicating that the vehicle traveling information corresponds to an on-duty period, “off-duty” indicating that the vehicle traveling information corresponds to an off-duty period, and “pending” indicating that the determination is pending is stored.

Note that information held in the vehicle traveling information DB 13 indicated in FIG. 4 is one example, and information held in the vehicle traveling information DB 13 is not limited to the example indicated in FIG. 4. For example, the declaration information may be managed in a database different from the database of the vehicle traveling information.

### Processing Flow

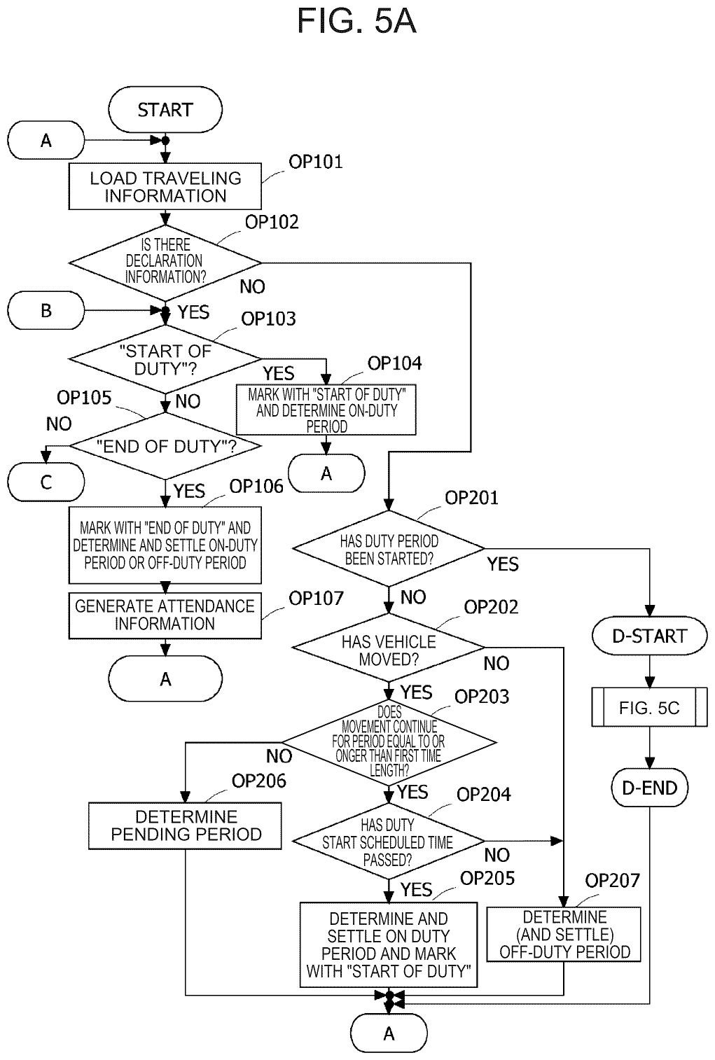

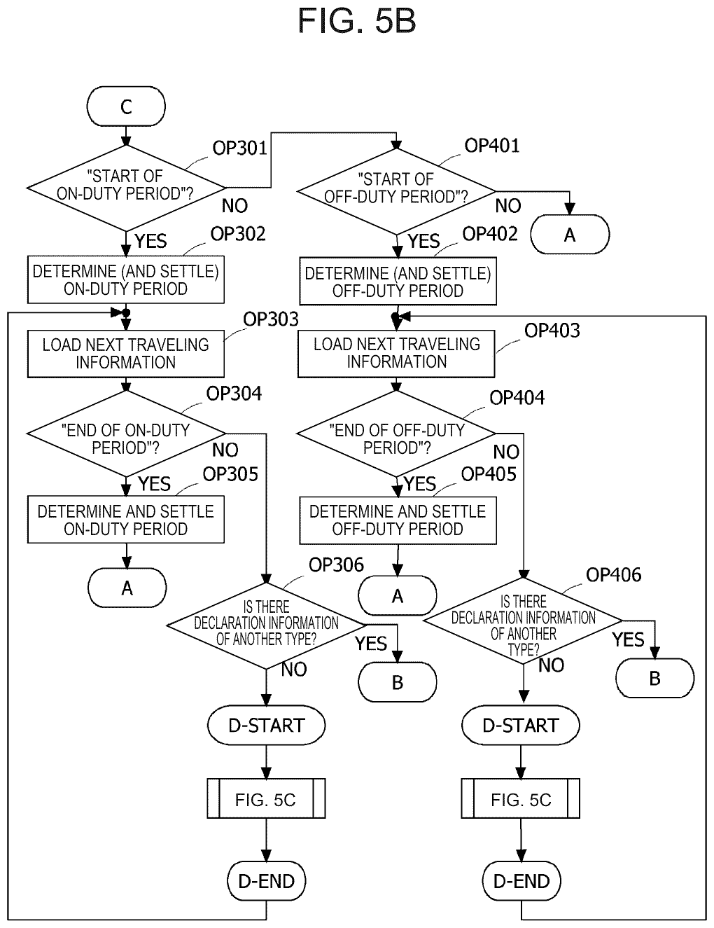

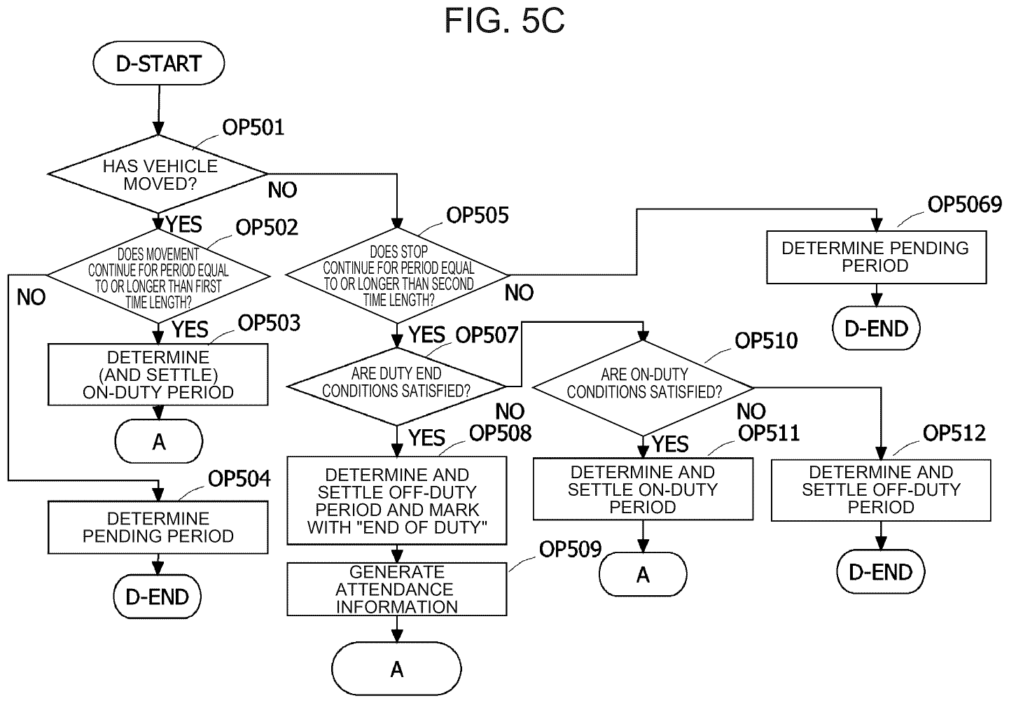

FIG. 5A, FIG. 5B and FIG. 5C are one example of a flowchart of the generation processing of the attendance information of the management terminal 1. The processing from FIG. 5A to FIG. 5C is processing when the vehicle traveling information of the vehicle 2 held in the vehicle traveling information DB 13 is processed record by record in chronological order. The processing indicated in FIG. 5A is, for example, executed for one vehicle 2 (or one driver) with a period of one day, one week, one month, or the like. The processing from FIG. 5A to FIG. 5C ends, for example, when processing is completed for all records for the vehicle 2 within the vehicle traveling information DB 13. While a subject that executes the processing from FIG. 5A to FIG. 5C is the processor 101 of the management terminal 1, description will be provided using functional components as a subject for convenience sake.

In OP 101, the control unit 11 loads the oldest record among unprocessed records from the vehicle traveling information DB 13. Hereinafter, the loaded record to be processed of the vehicle traveling information DB 13 will be referred to as target vehicle traveling information for convenience sake. In OP 102, the control unit 11 determines whether or not declaration information is associated with the target vehicle traveling information. When declaration information is associated with the target vehicle traveling information (OP 102: Yes), the processing proceeds to OP 103. When declaration information is not associated with the target vehicle traveling information (OP 102: No), the processing proceeds to OP 201.

In OP 103, the control unit 11 determines whether or not the declaration information associated with the target vehicle traveling information indicates “start of a duty”. When the declaration information associated with the target vehicle traveling information indicates “start of a duty” (OP 103: Yes), the processing proceeds to OP 104. In OP 104, the control unit 11 marks a target record of the vehicle traveling information DB 13 with “start of a duty”, determines that the target vehicle traveling information corresponds to an on-duty period, and records that the target vehicle traveling information corresponds to the on-duty period in the target record of the vehicle traveling information DB 13.

Marking the record of the vehicle traveling information DB 13 with “start of a duty” is storing information indicating “start of a duty” in the field of start of the duty and end of the duty of the target record. Hereinafter, simple description of marking with “start of a duty” or “end of a duty” indicates storage of information indicating “start of a duty” or “end of a duty” in the field of start of the duty and end of the duty of the target record of the vehicle traveling information DB 13.

Further, recording that the vehicle traveling information corresponds to the on-duty period in the target record of the vehicle traveling information DB 13 is storing information indicating “on-duty” in the field of whether on-duty or off-duty of the target record. Hereinafter, description of determining whether an on-duty period, an off-duty period or a pending period includes recording of “on-duty”, “off-duty” or “pending” in the field of “whether on-duty or off-duty” of the corresponding record of the vehicle traveling information in the vehicle traveling information DB 13.

When the declaration information associated with the target vehicle traveling information does not indicate “start of a duty” (OP 103: No), the processing proceeds to OP 105. In OP 105, the control unit 11 determines whether or not the declaration information associated with the target vehicle traveling information indicates “end of a duty”. When the declaration information associated with the target vehicle traveling information does not indicate “end of a duty” (OP 105: No), the processing proceeds to OP 301 in FIG. 5B. When the declaration information associated with the target vehicle traveling information indicates “end of a duty” (OP 105: Yes), the processing proceeds to OP 106. In OP 106, the control unit 11 marks the target record of the vehicle traveling information DB 13 with “end of a duty” and determines that the target vehicle traveling information corresponds to an on-duty or off-duty period. Whether the target vehicle traveling information is an on-duty or off-duty period is determined in accordance with whether the immediately preceding settled vehicle traveling information is an on-duty or off-duty period. When the immediately preceding settled vehicle traveling information is an on-duty period, it is determined that the target vehicle traveling information is also an on-duty period. Further, when there is pending vehicle traveling information between the immediately preceding settled vehicle traveling information and the target vehicle traveling information, the control unit 11 determines that the pending vehicle traveling information is an on-duty period or off-duty period that is a period of the same type as the immediately preceding settled vehicle traveling information and settles the vehicle traveling information.

In OP 107, the control unit 11 settles one duty period, and thus generates attendance information for the one duty. Thereafter, the processing proceeds to OP 101, and processing for the next vehicle traveling information is started.

The processing from OP 201 to OP 206 is processing when the declaration information is not associated with the target vehicle traveling information (OP 102: No). In OP 201, the control unit 11 determines whether or not the duty period has already been started. In OP 201, for example, a positive determination result is obtained when there is no record for which “end of a duty” is stored in the field of start of the duty and end of the duty of vehicle traveling information DB 13 between the target record and a record that is before the target vehicle traveling information and for which “start of a duty” is stored in the latest field of start of the duty and end of the duty, and a negative determination result is obtained when there is a record for which “end of a duty” is stored in the field of start of the duty and end of the duty between the target record and the record that is before the target vehicle traveling information and for which “start of a duty” is stored in the field of start of the duty and end of the duty. When the duty period has already been started (OP 201: Yes), the processing proceeds to OP 501 in FIG. 5C. When the duty period has not been started (OP 201: No), the processing proceeds to OP 202.

In OP 202, the control unit 11 determines whether or not the vehicle 2 has moved. A positive determination result is obtained in OP 202 when there is a difference in position information between the target vehicle traveling information and the immediately preceding vehicle traveling information or when a speed included in the target vehicle traveling information is not 0. When the vehicle 2 has moved (OP 202: Yes), the processing proceeds to OP 203. When the vehicle 2 has not moved (OP 202: No), the processing proceeds to OP 207.

In OP 203, the control unit 11 determines whether or not the vehicle 2 continues to move for a period equal to or longer than a first time length. The determination in OP 203 can be made, for example, according to whether or not a time length of continuous records which are immediately before the target record and for which “pending” is stored in the field of whether on-duty or off-duty, is equal to or longer than the first time length in the vehicle traveling information DB 13. When the vehicle 2 does not continue to move for a period equal to or longer than the first time length (OP 203: No), the processing proceeds to OP 206. In OP 206, the control unit 11 determines the target vehicle traveling information as a pending period. Then, the processing proceeds to OP 101.

When the vehicle 2 continues to move for a period equal to or longer than the first time length (OP 203: Yes), the processing proceeds to OP 204. In OP 204, the control unit 11 determines whether or not the duty start scheduled time has passed with reference to the operation plan information DB 12. When the duty start scheduled time has passed (OP 204: Yes), it is estimated that the driver has started the duty, and the processing proceeds to OP 205.

In OP 205, the control unit 11 determines that the target vehicle traveling information corresponds to the on-duty period. Further, in OP 205, a pending period of at least the first time length exists immediately before the on-duty period. The control unit 11 also settles the pending period as the on-duty period and records “on-duty” in the field of “whether on-duty or off-duty” of the target record of the vehicle traveling information DB 13 included in the pending period. Further, the control unit 11 determines start of the immediately preceding pending period as a timing of start of the duty and marks a first record of the vehicle traveling information DB 13 with “start of a duty”. Hereinafter, settling the pending period as the on-duty period or the off-duty period includes recording “on-duty” in the field of “whether on-duty or off-duty” of the target record of the vehicle traveling information DB 13 included in the pending period. Thereafter, the processing proceeds to OP 101.

When it is not past the duty start scheduled time (OP 204: No), it is estimated that the vehicle 2 has moved for the purpose other than the duty of the driver of the vehicle 2, and the processing proceeds to OP 207. In OP 207, the control unit 11 determines that the target vehicle traveling information corresponds to the off-duty period. Further, when a pending period exists immediately before the off-duty period, the control unit 11 also settles the pending period as the off-duty period. Then, the processing proceeds to OP 101.

The processing indicated in FIG. 5B is processing when declaration information indicating an attendance type other than “start of a duty” and “end of a duty” is associated with the target vehicle traveling information. In OP 301, the control unit 11 determines whether or not the declaration information associated with the target vehicle traveling information indicates start of an on-duty period. The attendance type corresponding to the on-duty period is “loading”, “unloading”, “waiting” and “fueling” in the first embodiment. When the declaration information associated with the target vehicle traveling information indicates start of an on-duty period (OP 301: Yes), the processing proceeds to OP 302. When the declaration information associated with the target vehicle traveling information does not indicate start of an on-duty period (OP 301: No), the processing proceeds to OP 401.

In OP 302, the control unit 11 determines that the target vehicle traveling information corresponds to an on-duty period. Further, when a pending period exists immediately before the on-duty period, the control unit 11 also settles the pending period as the on-duty period.

In OP 303, the control unit 11 loads the next record from the vehicle traveling information DB 13 and acquires new target vehicle traveling information. In OP 304, the control unit 11 determines whether or not declaration information indicating end of an on-duty period is associated with the target vehicle traveling information. When declaration information indicating end of an on-duty period is associated with the target vehicle traveling information (OP 304: Yes), the processing proceeds to OP 305. In OP 305, the control unit 11 determines that the target vehicle traveling information corresponds to an on-duty period, and when a pending period exists immediately before the on-duty period, also settles the pending period as the on-duty period. Then, the processing proceeds to OP 101 in FIG. 5A.

When declaration information indicating end of an on-duty period is not associated with the target vehicle traveling information (OP 304: No), the processing proceeds to OP 306. The control unit 11 determines whether or not declaration information indicating an attendance type other than end of the on-duty period is associated with the target vehicle traveling information. When declaration information indicating an attendance type other than end of the on-duty period is associated with the target vehicle traveling information (OP 306: Yes), the processing proceeds to OP 103 in FIG. 5A. When the declaration information is not associated with the target vehicle traveling information (OP 306: No), the processing proceeds to OP 501 in FIG. 5C.

In OP 401, the control unit 11 determines whether or not the declaration information associated with the target vehicle traveling information indicates start of the off-duty period. Attendance types corresponding to the off-duty period are “waiting for loading” and “break” in the first embodiment. When the declaration information associated with the target vehicle traveling information indicates start of the off-duty period (OP 401: Yes), the processing proceeds to OP 402. When the declaration information associated with the target vehicle traveling information does not indicate start of the off-duty period (OP 401: No), the processing proceeds to OP 101 in FIG. 5A.

In OP 402, the control unit 11 determines that the target vehicle traveling information corresponds to an off-duty period. Further, when a pending period exists immediately before the off-duty period, the control unit 11 also settles the pending period as the off-duty period.

In OP 403, the control unit 11 loads the next record from the vehicle traveling information DB 13 and acquires new target vehicle traveling information. In OP 404, the control unit 11 determines whether or not declaration information indicating end of the off-duty period is associated with the target vehicle traveling information. When declaration information indicating end of the off-duty period is associated with the target vehicle traveling information (OP 404: Yes), the processing proceeds to OP 405. In OP 405, the control unit 11 determines that the target vehicle traveling information corresponds to an off-duty period, and when a pending period exists immediately before the off-duty period, also settles the pending period as the off-duty period. Then, the processing proceeds to OP 101 in FIG. 5A.

When declaration information indicating end of the off-duty period is not associated with the target vehicle traveling information (OP 404: No), the processing proceeds to OP 406. The control unit 11 determines whether or not declaration information indicating an attendance type other than end of the on-duty period is associated with the target vehicle traveling information. When declaration information indicating an attendance type other than end of the on-duty period is associated with the target vehicle traveling information (OP 406: Yes), the processing proceeds to OP 103 in FIG. 5A. When the declaration information is not associated with the target vehicle traveling information (OP 406: No), the processing proceeds to OP 501 in FIG. 5C.

FIG. 5C is processing when the declaration information is not associated with the target vehicle traveling information. In OP 501, the control unit 11 determines whether or not the vehicle 2 has moved. When the vehicle 2 has moved (OP 501: Yes), the processing proceeds to OP 502. When the vehicle 2 has not moved (OP 501: No), the processing proceeds to OP 505.

In OP 502, the control unit 11 determines whether or not the vehicle 2 continues to move for a period equal to or longer than the first time length. When the vehicle 2 continues to move for a period equal to or longer than the first time length (OP 502: Yes), the processing proceeds to OP 503. In OP 503, the control unit 11 determines that the target vehicle traveling information corresponds to an on-duty period. Further, when a pending period exists immediately before the on-duty period, the control unit 11 also settles the pending period as the on-duty period. Then, the processing proceeds to OP 101 in FIG. 5A.

When the vehicle 2 does not continue to move for a period equal to or longer than the first time length (OP 502: No), the processing proceeds to OP 504. In OP 504, the control unit 11 determines the target vehicle traveling information as a pending period. Then, the processing proceeds to processing in accordance with processing that has called the processing in FIG. 5C.

In OP 505, the control unit 11 determines whether or not the vehicle 2 continues to stop for a period equal to or longer than a second time length. The second time length is one example of a “first threshold time length”. When the vehicle 2 does not continue to stop for a period equal to or longer than the second time length (OP 505: No), the processing proceeds to OP 506. In OP 506, the control unit 11 determines the target vehicle traveling information as a pending period. Then, the processing proceeds to processing in accordance with processing that has called the processing in FIG. 5C.

When the vehicle 2 continues to stop for a period equal to or longer than the second time length (OP 505: Yes), the processing proceeds to OP 507. In OP 507, the control unit 11 determines whether or not duty end conditions are satisfied with reference to the operation plan information DB 12. The duty end conditions are, for example, that the position information included in the target vehicle traveling information is the duty end scheduled location of the operation plan information DB 12 and that the position information time included in the target vehicle traveling information is a time within a predetermined range from the duty end scheduled time. When the duty end conditions are satisfied (OP 507: Yes), the processing proceeds to OP 508.

In OP 508, the control unit 11 determines that the target vehicle traveling information corresponds to an on-duty period. Further, in OP 508, a pending period of at least the second time length exists immediately before the on-duty period. In the first embodiment, the control unit 11 settles the pending period as an off-duty period. In the first embodiment, the control unit 11 determines a start time point of the pending period immediately before the target vehicle traveling information as a timing of end of the duty and marks the record of the vehicle traveling information DB 13 with “end of the duty”.

In OP 509, the control unit 11 settles one duty period, and thus generates attendance information for the one duty. Then, the processing proceeds to OP 101 in FIG. 5A, and processing for the next vehicle traveling information is started.

When the duty end conditions are not satisfied (OP 507: No), the processing proceeds to OP 510. In OP 510, the control unit 11 determines whether or not on-duty conditions are satisfied with reference to the operation plan information DB 12. The on-duty conditions are, for example, (1) that the position information included in the target vehicle traveling information is a stop-off point included in the operation plan information DB 12, and the position information time point included in the target vehicle traveling information is a time within a predetermined range from the stop-off scheduled time, or (2) that the position information included in the target vehicle traveling information is a location such as a gas station where fueling is performed.

When the on-duty conditions are satisfied (OP 510: Yes), the processing proceeds to OP 511. In OP 511, the control unit 11 determines that the target vehicle traveling information corresponds to an on-duty period. Further, when a pending period exists immediately before the on-duty period, the control unit 11 also settles the pending period as the on-duty period. Then, the processing proceeds to OP 101 in FIG. 5A.

When the on-duty conditions are not satisfied (OP 510: No), the processing proceeds to OP 512. In OP 512, the control unit 11 determines that the target vehicle traveling information corresponds to an off-duty period. Further, when a pending period exists immediately before the off-duty period, the control unit 11 also settles the pending period as the off-duty period. Then, the processing proceeds to processing in accordance with the processing that has called the processing in FIG. 5C.

For example, when the driver has started operation while having forgotten declaration of start of the duty (OP 102: No, OP 201: No, OP 202: Yes), as a result of the vehicle 2 having moved for a period equal to or longer than the first time length (OP 203: Yes), and the time being checked against the duty start scheduled time of the operation plan information DB 12 (OP 204: Yes), a timing of start of the duty is determined (OP 205). For example, when the driver has forgotten declaration of end of the duty (OP 102: No, OP 201: Yes), as a result of a stop state of the vehicle 2 continuing for a period equal to or longer than the second time length (OP 501: No, OP 505: Yes), and the duty end conditions based on the operation plan information DB 12 being satisfied (OP 507: Yes), a timing of end of the duty is determined (OP 508).

For example, when the driver has forgotten declaration of waiting for loading (OP 102: No, OP 201: Yes), as a result of a stop state of the vehicle 2 continuing for a period equal to or longer than the second time length (OP 501: No, OP 505: Yes), and the on-duty conditions based on the operation plan information DB 12 being satisfied (OP 507: No, OP 510: Yes), a period of waiting for loading is determined as an on-duty period (OP 511). Note that while “waiting for loading” is an attendance type other than on-duty in the first embodiment, when there is no declaration information, all of “loading”, “unloading” and “waiting for loading” occur near the stop-off point and the stop-off scheduled time within the operation plan information, and thus, these attendance types cannot be distinguished from one another. Thus, in the first embodiment, the period is set as an on-duty period to avoid disadvantage of the driver.

For example, when the driver has declared start of a break (OP 101: Yes, OP 401: Yes), but has forgotten declaration of end (OP 404: No, OP 406: No), as a result of a stop state of the vehicle 2 continuing for a period equal to or longer than the second time length (OP 501: No, OP 505: Yes), and neither the duty end conditions nor the on-duty conditions based on the operation plan information DB 12 being satisfied (OP 507: No, OP 510: No), a period during which the driver has taken a break is determined as an off-duty period (OP 512). The vehicle 2 starts moving after the break (OP 102: No, OP 201: Yes), and thus, as a result of movement continuing for a period equal to or longer than the first time length (OP 501: Yes, OP 502: Yes), a period required for movement after the break is determined as an on-duty period (OP 503), and, as a result, end of the off-duty period of the break and a timing of start of the on-duty period by the movement thereafter are determined.

Note that each of the first time length that is a threshold of a movement duration of the vehicle 2 and the second time length that is a stop duration time length may be arbitrarily set by a transport service provider that is a manager of the management terminal 1 and the vehicle 2. The generated attendance information may be, for example, transmitted to a predetermined device in response to a request or may be displayed on a predetermined display or may be output as a file in a predetermined format.

The generation processing of the attendance information indicated from FIG. 5A to FIG. 5C is performed through batch processing on the vehicle traveling information and the declaration information in a predetermined period acquired in advance from the center server 3, the processing is not limited to this. The center server 3 may transfer the vehicle traveling information and the declaration information to the management terminal 1 immediately after receiving the vehicle traveling information and the declaration information from the vehicle 2, and the management terminal 1 may perform the generation processing of the attendance information indicated from FIG. 5A to FIG. 5C through real-time processing every time the vehicle traveling information and the declaration information are transmitted from the center server 3.

### Operational Effects of First Embodiment

According to the first embodiment, the driver of the vehicle 2 only requires to operate the declaration screen of the attendance information to declare an attendance type and, for example, even when the driver has forgotten declaration, an on-duty period and an off-duty period are determined based on the vehicle traveling information and the operation plan information. Thus, according to the first embodiment, an input work regarding attendance of the driver of the vehicle can be simplified. Further, an on-duty period and an off-duty period are determined based on movement and stop of the vehicle 2 from the vehicle traveling information, so that it is possible to reduce variance with actual attendance of the driver.

### Modification

In the first embodiment, the generation processing of the attendance information (from FIG. 5A to FIG. 5C) has been described as processing when processing is performed on each record of the vehicle traveling information DB 13. The generation processing of the attendance information is not limited to this, and the processing can be collectively performed on the records of the vehicle traveling information DB 13 included in a predetermined period.

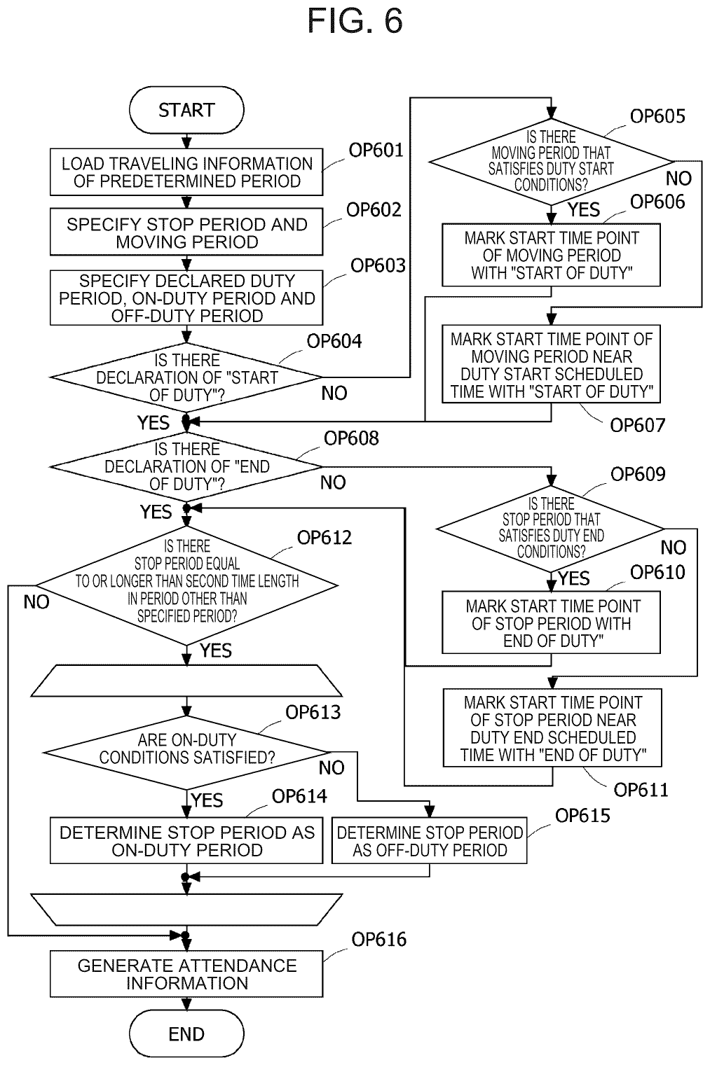

FIG. 6 is an example of a flowchart of generation processing of attendance information according to a modification. The processing indicated in FIG. 6 is, for example, executed for one vehicle 2 (or one driver) with a period including one duty, such as once a day.

In OP 601, the control unit 11 loads records in a predetermined period from the vehicle traveling information DB 13. The predetermined period for which records of the vehicle traveling information DB 13 are to be loaded is, for example, a period that can sufficiently include one duty. More specifically, the predetermined period is, for example, a period from the duty start scheduled time indicated by the operation plan information to after a predetermined time length from the duty end scheduled time for the next duty of the settled latest attendance information. However, the predetermined period is not limited to the above.

In OP 602, the control unit 11 specifies a stop period and a moving period for the vehicle 2 based on the vehicle traveling information in the predetermined period. For example, a period during which the vehicle traveling information for which the speed is 0 continues may be specified as the stop period. A period during which the vehicle traveling information for which the speed is not 0 continues may be specified as the moving period. For example, a period during which the vehicle traveling information including the same position information as position information of the last vehicle traveling information continues may be specified as the stop period. A period during which the vehicle traveling information including position information different from position information of the last vehicle traveling information continues may be specified as the moving period.

In OP 603, the control unit 11 specifies a duty period, an on-duty period, and an off-duty period based on the declaration information in the predetermined period. The duty period is a period from start of the duty to end of the duty. In OP 603, for example, when declaration information indicating “end of the duty” corresponding to declaration information indicating “start of the duty” does not exist, the duty period is not specified. Further, when declaration information indicating attendance types of start and end do not exist as a set, the on-duty period or the off-duty period corresponding to the attendance types is not specified.

In OP 604, the control unit 11 determines whether or not there is declaration information indicating “start of the duty”. When there is declaration information indicating “start of the duty” (OP 604: Yes), the processing proceeds to OP 608. When there is no declaration information indicating “start of the duty” (OP 604: No), the processing proceeds to OP 605.

In OP 605, the control unit 11 determines whether or not there is a moving period that satisfies duty start conditions. The duty start conditions are, for example, that the period is started within a predetermined range before and after the duty start scheduled time in the operation plan information and position information at a movement start time point is a duty start location. When there is a moving period that satisfies the duty start conditions (OP 605: Yes), the processing proceeds to OP 606. In OP 606, the control unit 11 marks a record of the vehicle traveling information DB 13 at a start time point of the moving period with “start of the duty”. When there is no moving period that satisfies the duty start conditions (OP 605: No), the processing proceeds to OP 607. In OP 607, the control unit 11 marks a record of the vehicle traveling information DB 13 at a start time point of the moving period closest to the duty start scheduled time with “start of the duty”. The moving period closest to the duty start scheduled time also includes the moving period including the duty start scheduled time.

In OP 608, the control unit 11 determines whether or not there is declaration information indicating “end of the duty”. When there is declaration information indicating “end of the duty” (OP 608: Yes), the processing proceeds to OP 612. When there is no declaration information indicating “end of the duty” (OP 608: No), the processing proceeds to OP 609.

In OP 609, the control unit 11 determines whether or not there is a stop period that satisfies duty end conditions. The duty end conditions are, for example, that the period is started within a predetermined range before and after the duty end scheduled time in the operation plan information and that position information of the vehicle 2 in the stop period is a duty end location. When there is a stop period that satisfies the duty end conditions (OP 609: Yes), the processing proceeds to OP 610. In OP 610, the control unit 11 marks a record of the vehicle traveling information DB 13 at a start time point of the stop period with “end of the duty”. When there is no stop period that satisfies the duty end conditions (OP 609: No), the processing proceeds to OP 611. In OP 611, the control unit 11 marks a record of the vehicle traveling information DB 13 at a start time point of the stop period closest to the duty end scheduled time with “end of the duty”. The stop period closest to the duty end scheduled time includes the stop period including the duty end scheduled time.

In OP 612, the control unit 11 determines whether or not there is a stop period equal to or longer than the second time length in a period other than the on-duty period and the off-duty period specified based on the declaration information in OP 603. When there is a stop period equal to or longer than the second time length in a period other than the on-duty period and the off-duty period specified based on the declaration information (OP 612: Yes), it is estimated that the driver has forgotten declaration of attendance, and the processing proceeds to OP 613. When there is no stop period equal to or longer than the second time length in a period other than the on-duty period and the off-duty period specified based on the declaration information (OP 612: No), it is estimated that the driver has not forgotten declaration of attendance, and the processing proceeds to OP 616.

The processing from OP 613 to OP 615 is repeatedly executed for each stop period equal to or longer than the second time length in a period other than the on-duty period and the off-duty period specified based on the declaration information. In OP 613, the control unit 11 determines whether or not the stop period satisfies on-duty conditions. The on-duty conditions are, for example, (A) that the position information of the vehicle 2 in the stop period indicates a stop-off point included in the operation plan information, and a start time or an end time of the stop period is within a predetermined range before and after the stop-off scheduled time at the stop-off point included in the operation plan information, or (B) that the position information of the vehicle 2 in the stop period indicates a fueling location such as a gas station.

When the stop period satisfies the on-duty conditions (OP 613: Yes), the processing proceeds to OP 614. In OP 614, the control unit 11 determines the stop period as an on-duty period. When the stop period does not satisfy the on-duty conditions (OP 613: No), the processing proceeds to OP 615. In OP 615, the control unit 11 determines the stop period as an off-duty period. If the processing from OP 613 to OP 615 is executed for each stop period equal to or longer than the second time length in a period other than the on-duty period and the off-duty period specified based on the declaration information, the processing proceeds to OP 616.

In OP 616, the control unit 11 generates attendance information for one duty in the predetermined period. Then, the processing indicated in FIG. 6 ends.

### OTHER EMBODIMENTS

The above-described embodiment is merely an example, and the present disclosure can be implemented with a change being made as appropriate without departing from the gist.

While in the first embodiment, the attendance information is generated based on the declaration information of the driver of the vehicle 2, the vehicle traveling information of the vehicle 2, and the operation plan information, the attendance information may be generated based on the declaration information of the driver of the vehicle 2 and the vehicle traveling information of the vehicle 2. In this case, for example, all stop periods equal to or longer than the second time length in a period other than the on-duty period and the off-duty period specified based on the declaration information may be determined as off-duty periods. In this case, the processing is simplified, so that processing load related to the management terminal 1 can be reduced.

While in the first embodiment, the declaration information of the attendance status is input from an in-vehicle touch panel, the input method is not limited to this. For example, the declaration information of the attendance status may be input on a user terminal such as a smartphone, a tablet terminal or a PC. These user terminals cannot acquire a speed of the vehicle 2, and thus, the vehicle traveling information does not include a speed. Further, the position information included in the vehicle traveling information is position information acquired by the user terminal.

While in the first embodiment, the management terminal 1 generates the attendance information, for example, the center server 3 may generate the attendance information and transmit the attendance information to the management terminal 1. Further, the declaration information of the attendance status of the driver may be transmitted to a server managed by a company to which the driver belongs or a server of an external organization that is requested by the company to which the driver belongs to manage attendance instead of the center server 3.

The processing and means described in the present disclosure can be freely combined and implemented unless technical inconsistency arises.

Further, the processing described as being performed by one device may be shared and executed by a plurality of devices. Alternatively, the processing described as being performed by different devices may be executed by one device. In a computer system, what kind of hardware components (server components) is used to implement each function can be flexibly changed.

The present disclosure can be also implemented by a computer program having the functions described in the above-described embodiment being supplied to a computer, and one or more processors of the computer reading and executing the program. Such a computer program may be provided to the computer by a non-transitory computer-readable storage medium that can be connected to a system bus of the computer or may be provided to the computer via a network. The non-transitory computer-readable storage medium includes, for example, an arbitrary type of disk such as a magnetic disk (such as a Floppy (registered trademark) disk, and a hard disk driver (HDD)), and an optical disk (such as a CD-ROM, a DVD disk and a Blu-ray disk), a read only memory (ROM), a random access memory (RAM), an EPROM, an EEPROM, a magnetic card, a flash memory, an optical card, and an arbitrary type of medium appropriate for storing an electronic command.

What is claimed is:

1. An information processing apparatus comprising a control unit that executes:
for a predetermined period,
acquiring traveling information of a first vehicle to be used by a first user, the traveling information including at least position information and a time at which the position information is acquired;
acquiring declaration information regarding an attendance status declared from the first user; and
generating attendance information of the first user based on the traveling information of the first vehicle and the declaration information.

2. The information processing apparatus according to claim 1, wherein:
one piece of declaration information includes one of information indicating start of a duty, end of a duty, start and end of an on-duty period, and start and end of an off-duty period, and a time; and
the control unit
specifies the start of the duty, the end of the duty, the on-duty period and the off-duty period based on one or a plurality of pieces of declaration information in the predetermined period, and
when a first stop period of the first vehicle, equal to or longer than a first threshold time length exists in a period other than the on-duty period and the off-duty period specified based on the one or the plurality of pieces of declaration information, determines the first stop period as the off-duty period.

3. The information processing apparatus according to claim 1, wherein:
one piece of declaration information includes one of information indicating start of a duty, end of a duty, start and end of an on-duty period, and start and end of an off-duty period, and a time; and
the control unit
generates the attendance information further based on operation plan information including at least a duty start scheduled time and a duty start scheduled location, and a duty end scheduled time and a duty end scheduled location of the first vehicle in the predetermined period,
in generation of the attendance information,
specifies the start of the duty, the end of the duty, the on-duty period and the off-duty period based on one or a plurality of pieces of declaration information in the predetermined period,
when a first stop period of the first vehicle, equal to or longer than a first threshold time length exists in a period other than the on-duty period and the off-duty period specified based on the one or the plurality of pieces of declaration information,
(A) when declaration information indicating the end of the duty does not exist immediately before the first stop period, and hours of the first stop period and a position of the first vehicle respectively correspond to the duty end scheduled time and the duty end scheduled location included in the operation plan information, determines a start time point of the first stop period as the end of the duty,
(B) when the position of the first vehicle in the first stop period is a predetermined location, determines the first stop period as the on-duty period,
(C) when the position of the first vehicle in the first stop period is neither a location included in the operation plan information nor the predetermined location, determines the first stop period as the off-duty period, and
when declaration information indicating the start of the duty does not exist immediately before a first moving period, and the first moving period of the first vehicle, equal to or longer than a second threshold time length exists near the duty start scheduled time, determines a start time point of the first moving period as the start of the duty.

4. The information processing apparatus according to claim 1, wherein the declaration information is input to a terminal mounted on the first vehicle and acquired from the terminal.

5. A method to be executed by a computer, the method comprising:
for a predetermined period,
acquiring traveling information of a first vehicle to be used by a first user, the traveling information including at least position information and a time at which the position information is acquired;
acquiring declaration information regarding an attendance status declared from the first user; and
generating attendance information of the first user based on the traveling information of the first vehicle and the declaration information.
